(19) United States
(12) Patent Application Publication
(10) Pub. No.: US 2022/0081834 A1
(43) Pub. Date: Mar. 17, 2022

(54) PROCESS AND SYSTEM FOR TREATING VAPOURS RELEASED FROM LIGNOCELLULOSE BIOMASS DURING ACID TREATMENT

(71) Applicant: VALMET AB, Sundsvall (SE)

(72) Inventor: Naveen CHENNA, Tampere (FI)

(73) Assignee: VALMET AB, Sundsvall (SE)

(21) Appl. No.: 17/424,659

(22) PCT Filed: Jan. 17, 2020
(86) PCT No.: PCT/SE2020/050044

§ 371 Date: Jul. 21, 2021

(30) Foreign Application Priority Data
Jan. 22, 2019 (SE) 1950068-5

(51) Int. Cl. D21C 11/00; D21C 3/00; C09F 3/02; C11D 9/00; D21C 11/06

(52) U.S. Cl. CPC D21C 11/0007; D21C 3/00; D21C 11/06; C11D 9/005; C09F 3/02

(57) ABSTRACT

The invention relates to a process for treating vapours released from lignocellulose biomass during acid treatment at elevated temperature of the lignocellulose biomass. The process comprises condensing (3) the vapours to produce a condensate, adjusting (4) the pH of the condensate to about 9, and decanting (5) the condensate to produce turpentine, and may further comprise distilling (6) the mixture remaining after decanting to produce furfuraland a reject comprising tall oil fatty acids. The invention also relates to a corresponding system for treating vapours released from lignocellulose biomass during acid treatment at elevated temperature of the lignocellulose biomass.

### TECHNICAL FIELD

The invention relates to a process and a system for treating vapours released from lignocellulose biomass during acid treatment at elevated temperature of the lignocellulose biomass.

### BACKGROUND

Processes for acid treatment of lignocellulose biomass at elevated temperature, such as prehydrolysis/pretreatment or a main treatment process of wood chips, wood pulp, saw dust, or any other wood-based biomass are known in the art.

Acid treatment processes as described above may result in valuable by-products such as turpentine, furfural, acetic acid, formic acid and etc. Turpentine, furfural and water evaporate together from the reaction mixture of the treatment process and can be condensed to separate the different components. The separation efficiency is normally low and create occasional problems in smooth operation of the process since the acid treatment processes do not only result in turpentine and furfural, but may also dissolve low and high molecular weight acids, lipids, resins and other extractive components in water/solvent. These extractives along with turpentine, furfural and water travel together to the condensation plant and may create deposition problems all over the separation system. This scaling takes place as the resins and acids precipitates from the system. The precipitation and scaling essentially create several layers in the tanks before a decanting process of turpentine or distillation of furfural. Furthermore, the dissolved extractives, water, turpentine and furfural may form an inseparable layer which not only lowers the separation efficiency but also drastically reduces the final product quality.

### SUMMARY

An object of the invention is to solve or improve on at least some of the problems mentioned above in the background section.

These and other objects are achieved by the present invention by means of a process and a system according to the independent claims.

According to a first aspect of the invention, a process for treating vapours released from lignocellulose biomass during acid treatment at elevated temperature of the lignocellulose biomass is provided, or in other words a process for treating vapours resulting from acid treatment at elevated temperature of lignocellulose biomass. The process comprises condensing the vapours to produce a condensate and adjusting the pH of the condensate to about 9. In embodiments, the process comprises decanting the condensate to produce turpentine. In embodiments, the process comprises distilling the condensate and/or the mixture remaining after decanting to produce furfural and a reject comprising tall oil fatty acids.

In embodiments, the process comprises, prior to the condensing, separating the vapours released from the lignocellulose biomass. Such a process may alternatively be described as a process for treating lignocellulose biomass having been subject to acid treatment at elevated temperature, where the acid and heat treated biomass is separated into a solid portion and a vapour. Alternatively, separation is performed prior to the process according to the first aspect of the invention.

It is understood that the vapours referred to above (vapours released from lignocellulose biomass during acid treatment at elevated temperature) are not necessarily processed immediately as released from the acid treatment, i.e. during the actual acid treatment, but may be received for processing during discharge from a continuous or batch-wise treatment vessel. It is furthermore understood that a pH of about 9, refers to a pH which is 9 or close to 9, for example within an interval between 8.95 and 9.05 or between 8.9 and 9.1.

The invention is based on the insight that deposition in the ducts, decanters, distillation columns and storage tanks is caused by accumulated extractives which start to polymerize, and that polymerization of dissolved extractives can be stopped by adjusting the pH of the condensate. Such pH adjustment may be achieved by addition of an alkali such as caustic soda, which dissolves most of the extractives being a complex mixture of fats, waxes, resin acids, fatty acids, phenols and tannins in water. This allows turpentine to be easily separated and decanted to produce a high-quality turpentine. The dissolved extractive water mixture contains furfural, and quality furfural can be obtained by distillation process.

The invention is furthermore based on the insight that the furfural separated water mixture, i.e. the reject, contains valuable components such as tall oil fatty acids, making the reject usable as-is in hydrolysis tanks or in waste water treatment systems where it acts as carbon rich water source, or for further processing to produce soap or tall oil.

According to a second aspect of the invention, a process for treating lignocellulose biomass is provided, which process comprises acid treatment at elevated temperature of lignocellulose biomass, separating the acid and heat treated biomass into a solid portion and a vapour, followed by the steps of the first aspect of the invention.

In other embodiments according to the first or second aspect of the invention, the vapours may be subject to two or more condensing steps (depending on the temperature of the vapours). For example, an uncondensed fraction of the vapours from the (first) step of condensing may be subject to an additional step of condensing to produce a second condensate, where the second condensate may be decanted to produce turpentine, and wherein the distilling step further comprises distilling the condensate from the (first) step of condensing and the mixture remaining after decanting to produce furfural. The decanting of the pH-adjusted condensate results in a high-quality turpentine.

In embodiments according to the first or second aspect of the invention, the step of adjusting comprises adding an alkali to adjust the pH. The alkali may be selected from a group comprising NaOH, Ca(OH)2, Mg(OH)2, white liquor and weak white liquor. The alkali may be added directly to the condensate, for example by means of a separate or external mixing device. The alkali may alternatively be added to the vapours, i.e. prior to condensing, for example by being sprayed into the separated vapours to mix therewith, or by means of a separate or external mixing device. In embodiments, the step of separating is performed using at least one cyclone, and the alkali is sprayed into the cyclone during separation. The person skilled in the art realizes that other positions or methods for addition of alkali are foreseeable within the scope of the invention as long as the intended result is achieved, i.e. adjustment of pH.

In embodiments according to the first or second aspect of the invention, the process further comprises adjusting the temperature of the condensate to 55° C. or 60° C. or higher. In embodiments comprising two condensing steps, the temperature of the first condensate may be adjusted to about 80-90° C., and the temperature of the second condensate may be adjusted to about 55-70° C. These embodiments are based on the insight that scaling takes place at low temperatures as the resins and acids precipitate from the system. Dissolved extractives in water mixture can precipitate out at very low temperatures and therefore the process conditions should be adjusted so that temperature is above 55 or 60° C. at all times.

In embodiments according to the first or second aspect of the invention, the reject resulting from distillation, i.e. the water mixture remaining after distillation is used to produce valuable by-products. For example, the reject may be subjected to a tall oil separation process in which the tall oil fatty acids and any dissolved and undissolved extractives are used to produce tall oil. Alternatively, the reject may be subjected to saponification to produce soap.

According to a third aspect of the invention, a system for treating vapours released from lignocellulose biomass during acid treatment at elevated temperature of the lignocellulose biomass is provided, which system comprises at least one condenser arranged to condense the vapours to produce a condensate, a pH adjusting arrangement comprising addition means configured to add an alkali before and/or after the at least one condenser. In embodiments, the system comprises at least one decanting device configured to decant the condensate to produce turpentine. In embodiments, the system comprises a distilling device configured to distill the condensate from the at least one condenser and/or the mixture remaining after decanting to produce furfural and a reject comprising tall oil fatty acids. The system may also comprise separating means arranged to separate the vapours released from the lignocellulose biomass.

According to a fourth aspect of the invention, there is provided a system for treating lignocellulose biomass, which system comprises a reactor vessel configured for acid treatment at elevated temperature of the lignocellulose biomass, separating means arranged to separate the vapours released from the lignocellulose biomass, and the at least one condenser, pH adjusting arrangement and distilling device of the system according to the third aspect of the invention.

In embodiments of the system according to the third or fourth aspects of the invention, the system further comprises an additional condenser configured to condense an uncondensed fraction of the vapours from the condenser to produce a second condensate, wherein the at least one decanting device is configured to decant the second condensate to produce turpentine, wherein the distilling device is configured to distill the condensate from the (first) condenser and the mixture remaining after decanting.

Many different embodiments are foreseeable for the addition of alkali. For example, the addition means may be configured to add alkali directly to the condensate, or may be configured to spray alkali into the vapours, or may comprise a mixing device configured to mix the alkali with the vapours or condensate. In embodiments comprising separating means comprising at least one cyclone, the addition means may be configured to spray alkali into into the cyclone to mix with the separated vapours therein.

In embodiments of the system according to the third or fourth aspects of the invention, the pH adjusting arrangement further comprises pH measurement means and control means configured to control the addition means in response to a control signal from the pH measurement means.

The features of the embodiments described above are combinable in any practically realizable way to form embodiments having combinations of these features. Further, all features and advantages of embodiments described above with reference to the first and second aspects of the invention may be applied in corresponding embodiments of the third and fourth aspects of the invention.

### BRIEF DESCRIPTION OF THE DRAWINGS

Above discussed and other aspects of the present invention will now be described in more detail using the appended drawings, which show presently preferred embodiments of the invention, wherein:

FIG. 1 shows a flow chart illustrating an embodiment of the process according to the first or second aspect of the invention;

FIG. 2 shows a flow chart illustrating another embodiment of the process according to the first or second aspect of the invention;

FIG. 3 schematically illustrates an embodiment of a system according to the third or fourth aspect of the invention, and

FIG. 4 schematically illustrates another embodiment of a system according to the third or fourth aspect of the invention.

### DETAILED DESCRIPTION

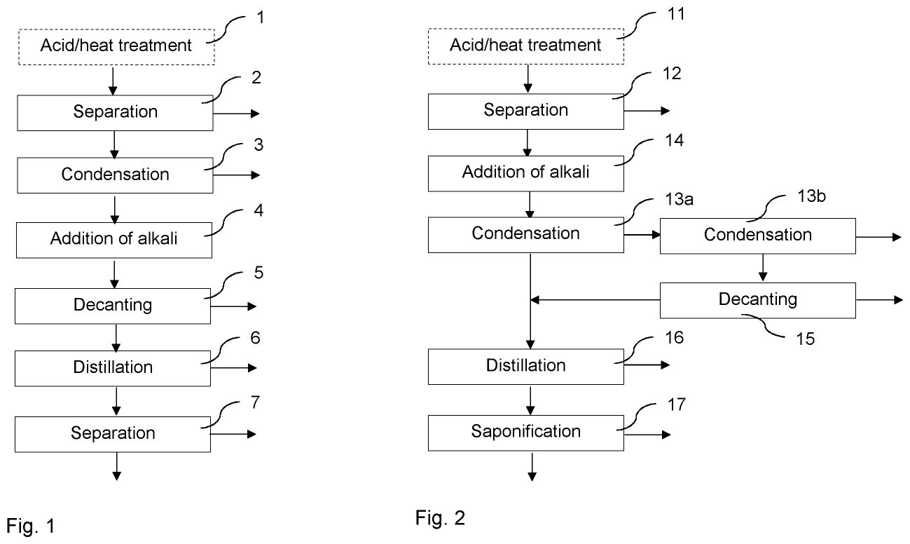

FIG. 1 shows a flow chart illustrating an embodiment of the process according to the first or second aspect of the invention, which process comprises acid treatment at elevated temperature 1 of the lignocellulose biomass (not part of the embodiment to the first aspect of the invention).

The process further comprises separation 2 of the acid/heat treated biomass into a solid portion and a vapour (blow steam), for example by means of a cyclone. Thereafter, the vapours are subjected to a condensation step 3. The condensation may include adjusting the temperature of the condensate to 55° C. or higher. The pH of the condensate is adjusted 4 for example by means of addition of an alkali. In this embodiment, the alkali is added to the condensate directly, for example by means of an external mixing device. In other embodiments, the alkali may be added to the vapour before condensing. The pH adjusted condensate is thereafter decanted 5 to produce turpentine. The reject from decanting is subjected to distillation 6 to produce furfural. The reject resulting from distillation, i.e. the water mixture remaining after distillation is subjected to a tall oil separation step 7 in which the tall oil fatty acids and any dissolved and undissolved extractives are used to produce tall oil. In other embodiments, the reject may be subjected to saponification to produce soap.

FIG. 2 shows a flow chart illustrating another embodiment of the process according to the first or second aspect of the invention. This embodiment is similar to the embodiment in FIG. 1, and comprises acid treatment at elevated temperature 11 of the lignocellulose biomass (not part of the embodiment to the first aspect of the invention), separation 12, pH adjustment 14 by means of addition of an alkali, and condensation 13a. In this embodiment, the alkali is added to the vapours prior to condensation, for example by means of an external mixing device, or by spraying into a cyclone used for separation. This embodiment however differs from the embodiment shown in FIG. 1 in that it comprises an additional condensation step 13b which condenses an uncondensed fraction from the first condensation step 13a. The condensate from the condensing 13b is subject to decanting 15 to produce turpentine. Distillation 16 is performed on the condensate from condensation step 13a and the reject from decanting 15 to produce furfural. The reject resulting from distillation is subjected to saponification 17 to produce soap. Alternatively, the reject may be subjected to a tall oil separation step as described above with reference to FIG. 1. The condensation step 13a comprises adjusting the temperature of the condensate to about 80-90° C., and the additional condensation step 13b comprises adjusting the temperature to about 55-70° C.

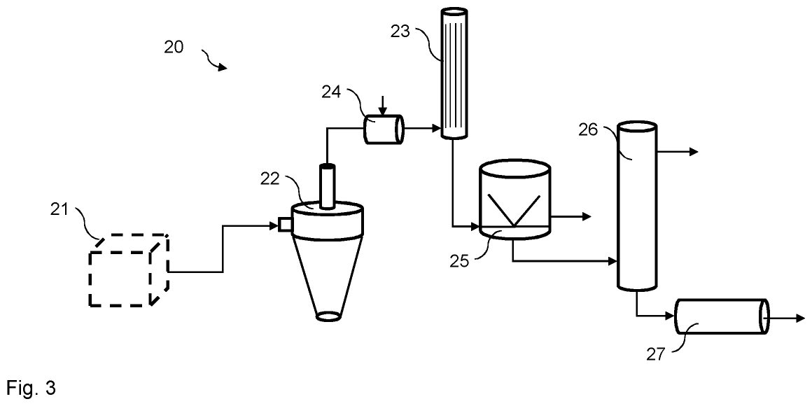

FIG. 3 schematically illustrates an embodiment of a system according to the third or fourth aspect of the invention. The system 20 comprises a reactor vessel 21 configured for acid treatment at elevated temperature of the lignocellulose biomass (not part of the embodiment to the third aspect of the invention), a cyclone 22 arranged to separate the vapours (blow steam) released from the lignocellulose biomass, a condenser 23 arranged to condense the vapours to produce a condensate, a pH adjusting arrangement comprising addition means 24 in the form of an external/separate mixer configured to add an alkali before the condenser 23, pH measurement means (not shown) and control means (not shown) configured to control the addition means in response to a control signal from the pH measurement means, a decanting device 25 configured to decant the condensate from the condenser 23 to produce turpentine, and a distilling device 26 configured to distill the mixture remaining after decanting to produce furfural and a reject comprising tall oil fatty acids. The condenser is configured to provide a condensate having a temperature of 55° C. or higher. A tall oil separation arrangement 27 is configured to subject the reject from the distilling device 26 to tall oil separation. In other embodiments, the separation arrangement is replaced with a saponification arrangement. In yet other embodiments, the tall oil separation or saponification arrangement is omitted altogether, and the reject is used as-is in for various purposes.

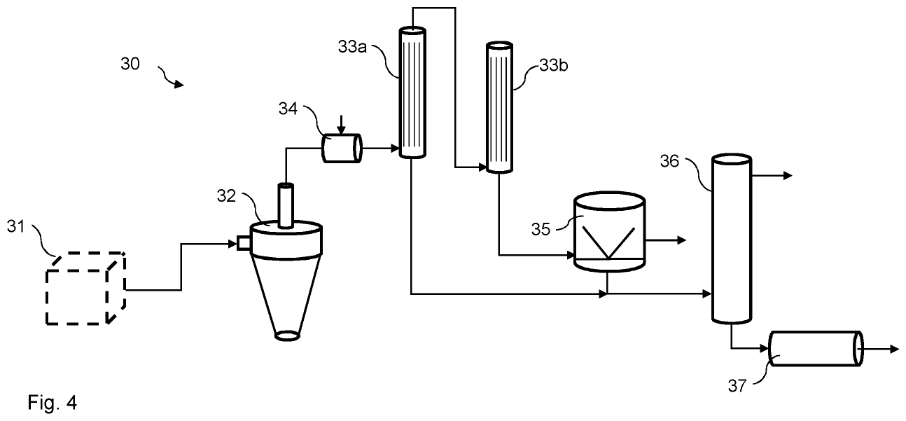

FIG. 4 schematically illustrates another embodiment of a system 30 according to the third or fourth aspect of the invention. This embodiment is similar to the embodiment in FIG. 3 in that it comprises a reactor vessel 31, a cyclone 32, a condenser 33a, a pH adjusting arrangement comprising addition means 34 in the form of an external/separate mixer configured to add an alkali before the condenser 33a, and a tall oil separation arrangement 37. This embodiment however differs from the embodiment shown in FIG. 3 in that it comprises an additional condenser 33b which condenses an uncondensed fraction from the first condenser 33a, where the condensate from the additional condenser is decanted by the decanter 35 to produce turpentine. The distilling device 36 is configured to distill the condensate from condenser 33a and the reject from the decanter 35 to produce furfural.

The description above and the appended drawings are to be considered as non-limiting examples of the invention. The person skilled in the art realizes that several changes and modifications may be made within the scope of the invention. For example, more than two condensation steps may be used, and other methods for adjusting the pH may be used. The scope of protection is determined by the appended patent claims.

1. Process for treating vapours released from lignocellulose biomass during acid treatment at elevated temperature of said lignocellulose biomass, said process comprising:
condensing said vapours to produce a condensate,
adjusting the pH of the condensate to about 9, and
decanting the condensate to produce turpentine.

2. The process according to claim 1, further comprising:
distilling the mixture remaining after decanting to produce furfural and a reject comprising tall oil fatty acids.

3. The process according to claim 1, further comprising
subjecting an uncondensed fraction of said vapours from said step of condensing to an additional step of condensing to produce a second condensate,
wherein said step of decanting comprises decanting the second condensate to produce turpentine, and
distilling the condensate from the step of condensing and the mixture remaining after decanting to produce furfural and a reject comprising tall oil fatty acids.

4. The process according to claim 2, further comprising:
Subjecting said reject resulting from said distilling to a tall oil separation process.

5. The process according to claim 2, further comprising:
Subjecting said reject to saponification to produce soap.

6. The process according to claim 1, wherein said adjusting comprises adding an alkali to adjust the pH.

7. The process according to claim 6, wherein said alkali is added to said condensate.

8. The process according to claim 6, wherein said alkali is sprayed into the vapours to mix therewith.

9. The process according to claim 6, wherein said alkali is mixed with the vapours and/or condensate by means of a separate mixing device.

10. The process according to claim 6, further comprising separating said vapours released from said lignocellulose biomass, wherein said separating is performed using at least one cyclone, and wherein said alkali is sprayed into the cyclone during separation.

11. The process according to claim 6, wherein said alkali is selected from a group comprising NaOH, Ca(OH)2, Mg(OH)2, white liquor and weak white liquor.

12. The process according to claim 1, further comprising:
adjusting the temperature of the condensate to 55° C. or higher.

13. The process according to claim 3, wherein said step of condensing comprises adjusting the temperature of the condensate to about 80-90° C., and
wherein said additional step of condensing comprises adjusting the temperature of the second condensate to about 55-70° C.

14. The process according to claim 1, wherein said acid treatment comprises a pretreatment or a main treatment process of wood chips, wood pulp, saw dust, or any other wood-based biomass.

15. The process according to claim 1, wherein said acid treatment comprises acid cooking of wood chips.

16. System for treating vapours released from lignocellulose biomass during acid treatment at elevated temperature of said lignocellulose biomass, said system comprising:
at least one condenser arranged to condense said vapours to produce a condensate,
at least one decanting device configured to decant the condensate to produce turpentine, and
a pH adjusting arrangement for adjusting the pH of the condensate prior to decanting, said arrangement comprising addition means configured to add an alkali upstream the at least one condenser or between the condenser and the decanting device.

17. The system according to claim 16, further comprising:
a distilling device configured to distill the mixture remaining after decanting to produce furfural and a reject comprising tall oil fatty acids.

18. The system according to claim 17, further comprising:
At least one tall oil separation arrangement configured to subject said reject to tall oil separation.

19. The system according to claim 17, further comprising:
At least one saponification arrangement configured to subject said reject to saponification.
